(19) United States
(12) Patent Application Publication
(10) Pub. No.: US 2006/0294393 A1
(43) Pub. Date: Dec. 28, 2006

(54) Remote biometric registration for vehicles

(76) Inventor: Clark E. Mc Call, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/166,744

(22) Filed: Jun. 24, 2005

(51) Int. Cl. H04K 1/00; H04L 9/00

(52) U.S. Cl. 713/186; 380/270

(57) ABSTRACT

Methods and apparatus are provided for remotely registering a user's biometric signature to a vehicle. A remote control comprises a user input, a wireless transmitter, biometric input, memory, user output and microcontroller coupling the other elements. The biometric input reads a user's biometric signature that is compressed, optionally encrypted and sent via the transmitter to the vehicle for registration. This identifies WHO is authorized to issue commands to the vehicle. After registration, the key-fob may send a biometric signature with each command that is compared with signatures stored in the vehicle memory and the command executed when there is a match. An optional user access level associated with each signature determines WHAT commands the vehicle will execute for that individual. The vehicle electronics system includes a receiver, microcontroller and memory for receiving, decrypting, storing, comparing biometric signatures and executing commands.

### TECHNICAL FIELD

The present invention generally relates to biometric registration, and more particularly to remote biometric registration for a vehicle.

### BACKGROUND

It is known in the electronic arts to use biometric screening for access control and other functions. For example, and without any intention to be limiting, a prospective entrant or user of a facility places a finger on a sensing device that records the individual's fingerprint and compares the fingerprint to a catalog of fingerprints of authorized users or entrants. If there is a match, then the prospective entrant or user is allowed access to whatever facility or function is controlled by the sensing device.

Non-limiting examples of other biometric data that can be used in biometric screening and may be used in such access control and other functions are multiple finger or hand prints, retinas, faces, body shapes, speech, walking gait, and any other type of physiological features that are substantially unique to an individual. In effect, each individual carries with him or her as a part of their body, the key to the door or whatever system is being guarded by the biometric lock. For convenience of description, the term “user” is intended to refer to the individual desiring to “open” the biometric lock, irrespective of the particular type of access control that it provides, and the term “biometric signature” is used to refer generally to whatever individual body feature or combination of body features is being used for identification, such as for example those previously listed above that are not provided with any intention to be limiting.

In order for a biometric system to operate, some mechanism is provided for registering authorized users. In vehicles, this has previously been handled at the vehicle. That is, the prospective user is taken to the vehicle, the vehicle biometric control system is placed in a learning mode and a biometric scanner at the vehicle is used to record that user's biometric signature. Once the individual's biometric signature has been recorded and stored in the vehicle, the vehicle system is returned to the normal operating mode. Thereafter, when the user desires access, his or her biometric signature is obtained and compared to the biometric signatures stored in memory. If there is a match, then access is granted, if not, then access is denied. However, having to go to the vehicle to register a new user is not always desirable. Accordingly, there continues to be a need for registration of biometric signatures for vehicle access and control that can be done remotely, preferable with a mobile system that is not tied to a particular location or vehicle.

FIG. 1 is a block diagram of a conventional key-fob control 20 for use with vehicles. Key-fob control 20 comprises pushbuttons 22 coupled to microcontroller 24 via leads or bus 23. Microcontroller 24 is in turn coupled to transmitter 26 via leads or bus 25, which is in turn coupled to antenna 28 by leads 27. Antenna 28 radiates RF signal 29 that is received and interpreted by control system 32 in vehicle 34. Pushbuttons 22 allow a user to input a desired command (e.g., lock/unlock, open/close, start/stop, etc.). Microcontroller 24 receives the user generated command from pushbuttons 22 and converts it to a signal in a format that will be recognized by the corresponding vehicle control system for the desired function. Transmitter 26 receives this signal from microcontroller 24 and sends it, appropriately modulated, to control system 32 of vehicle 34 via antenna 28 as RF signal 29. Battery 30 is coupled via leads 31 to those elements within key-fob 20 needing power. Key-fob control 20 of the prior art does not provide any biometric registration and verification capabilities.

FIG. 2 is a simplified flow chart illustrating method 120 for operation of prior art key fob 20 of FIG. 1. Method 120 begins with START 122 that occurs, for example, when batteries are inserted in key-fob 20. When initial step 124 determines that any of pushbuttons 22 have been activated, POWER-UP step 126 is executed and power is applied to the various elements of key-fob 20. Query 130 is then executed, that it determines whether or not the detected keystrokes comprise an allowed command. If the outcome of query 130 is NO (i.e., FALSE), then as shown by path 131, method 120 proceeds to RETURN TO SLEEP MODE step 134, and awaits another key-stroke as shown by path 135. If the outcome of query 130 is YES (i.e., TRUE), then method 120 advances to TRANSMIT FOB ID AND COMMAND step 132 and transmitter 26 of key-fob 40 sends the command represented by the particular pushbutton or combination of pushbuttons that have been pressed by the user to vehicle 34 along with the unique ID of the key-fob 20. Upon completion of transmit step 132, method 120 advances to sleep mode step 134 to await another user input. This prior art method 120 does not provide biometric registration and verification capabilities.

Accordingly, it is desirable to provide an improved biometric registration and control device and method, especially for vehicles, that is preferably mobile and allows remote registration of new users and remote access by users for controlling various vehicle functions. In addition, it is desirable that the registration and control apparatus and method be simple, rugged and reliable and not utilize physical contact with the vehicle control system. Furthermore, other desirable features and characteristics of the present invention will become apparent from the subsequent detailed description and the appended claims, taken in conjunction with the accompanying drawings and the foregoing technical field and background.

### BRIEF SUMMARY

An apparatus, such as a key-fob, is provided for remotely registering a biometric signature of a user to a vehicle. The apparatus comprises a biometric input for obtaining the biometric signature of the user, an RF transmitter for sending the biometric signature to the vehicle, and a microcontroller coupling the biometric input and the transmitter, and configured to read the user's biometric signature using the biometric input and send a message containing the biometric signature to the vehicle via the RF transmitter for registration within the vehicle. In a preferred embodiment, the biometric signature is compressed and encrypted prior to transmission and a command is included directing the vehicle to register the biometric signature. Once registered in the vehicle, then in the most secure mode, other command transmissions from the portable apparatus to the vehicle can include a biometric signature, which is compared to those registered in the vehicle and the command executed in the vehicle when there is a match.

A method is provided for remotely biometrically registering a new user to a vehicle using, preferably, a portable remote control apparatus such as a key-fob. The method comprises, in either order, (i) entering a command into the remote control apparatus indicative of a desire to biometrically register a new user to the vehicle and (ii) reading a biometric signature of the new user using a biometric sensor on the remote control apparatus, and then compressing and formatting the biometric signature obtained in the read step; and wirelessly transmitting the compressed and formatted biometric signature and registration command to the vehicle for registration therein. In a preferred embodiment, the biometric signature is encrypted prior to transmission. In a further preferred embodiment, a command access level can be associated with the biometric signature identifying those other commands that are allowed to be executed on behalf of the person holding the biometric signature.

### BRIEF DESCRIPTION OF THE DRAWINGS

The present invention will hereinafter be described in conjunction with the following drawing figures, wherein like numerals denote like elements, and:

FIG. 1 is a block diagram of a key-fob control for use with a vehicle according to the prior art;

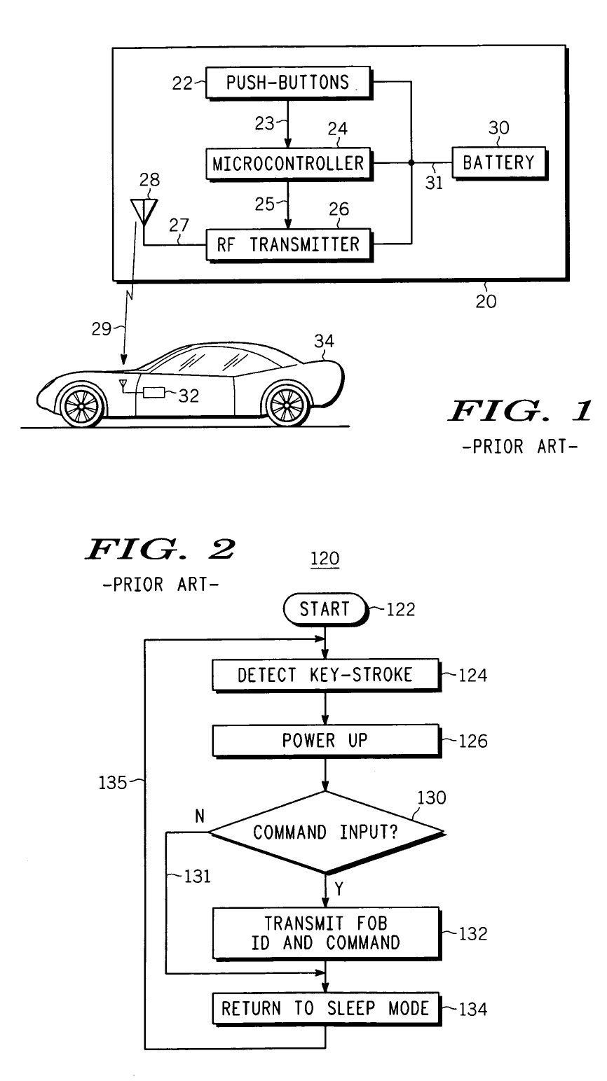

FIG. 2 is a simplified process flow chart illustrating a method of operating key fob control of FIG. 1 according to the prior art;

FIG. 3 is a block diagram of a biometric key-fob control according to an exemplary embodiment of the present invention;

FIG. 4 is a block diagram of a vehicle mounted, biometric registration and control system adapted to interface with the biometric key-fob control of FIG. 3 according to an exemplary embodiment of the present invention;

FIGS. 5-6 are simplified process flow charts illustrating several methods of operation of the biometric key-fob control of FIG. 3, according to exemplary embodiments of the present invention; and

FIG. 7 is a simplified process flow chart illustrating a method of operation of the vehicle mounted, biometric registration and control system of FIG. 4, according to an exemplary embodiment of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

As used herein, the term “key-fob” is intended to include any type of remote control device adapted to send commands and/or other data to a vehicle, irrespective of the vehicle function intended to be performed or controlled. It is preferred, but not essential, that the remote control device be portable. The elements forming the key-fob of the present invention may be stand-alone elements or incorporated in other portable devices, as for example and not with any intention to be limiting, a cell phone, personal digital assistant, wireless equipped personal computer or any other device able to remotely communicate with the vehicle. For convenience of description, it is assumed hereafter that a fingerprint is being used as the biometric signature, but this is merely by way of example and not intended to be limiting and that any unique personal feature can be used as a biometric signature, such as for example but not limited to those previously presented in the background.

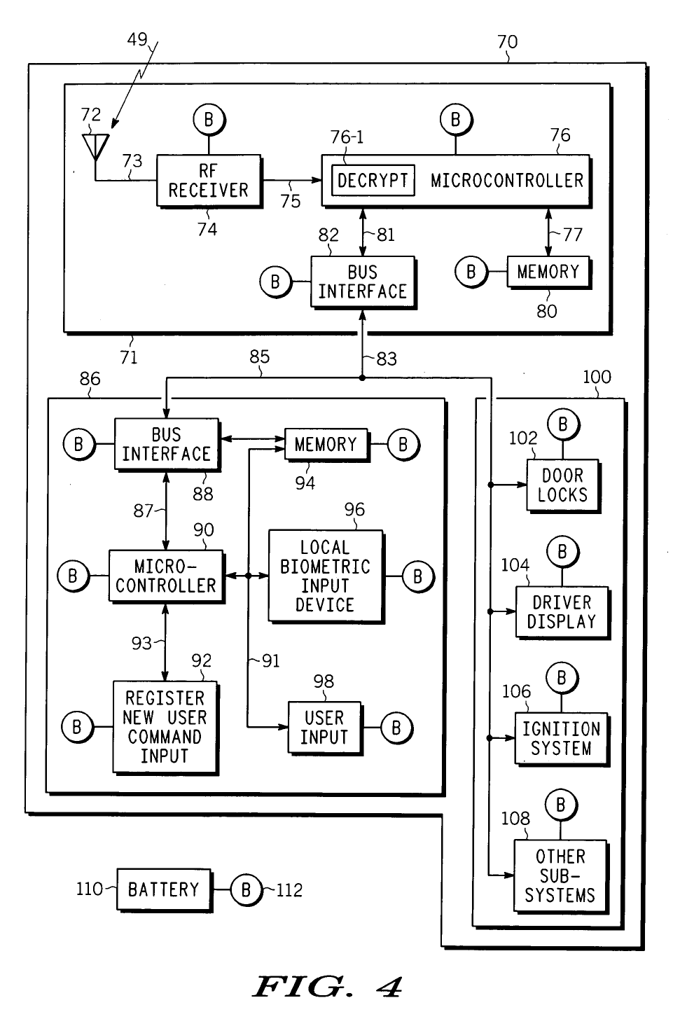

FIG. 3 is a block diagram of improved biometric key-fob control 40, according to an exemplary embodiment of the present invention, adapted to provide remote registration of biometric signature information in the vehicle and subsequent biometric signature access control signals. Biometric key-fob control 40 comprises user input 42 coupled to microcontroller 44 via leads or bus 43, which is in turn coupled to transmitter 46 via leads or bus 45, which is in turn coupled to antenna 48 by leads 47. Antenna 48 radiates RF signal 49 that is received and interpreted by control system 70 of vehicle 68. User input 42 allows a user to input a desired command (e.g., lock/unlock, open/close, start/stop, etc.). Microcontroller 44 receives the user generated command from user input 42 and converts it to a signal in a format that will be recognized by control system 70 of vehicle 68. Transmitter 46 receives this signal from microcontroller 44 and sends it, appropriately modulated, to vehicle control system 70 via antenna 48 as RF signal 49. Optional encrypt module 44-1 may be included as a part of microcontroller 44 implemented in hardware or software or provided as a separate stand-alone element. Battery 50 is coupled via leads 51 to those elements within biometric key-fob 40 needing power. Biometric key-fob 40 also comprises biometric input device 52, memory 54 and user output device 56, all conveniently coupled to microcontroller 44 by bus 53. While common bus 53 is useful for coupling elements 52, 54, 56 to microcontroller 44, individual leads or buses may also be used. User input 42 may have the form of push-button switches or any other convenient means of providing information or commands. Non-limiting examples of suitable input devices are push switches, touch switches, touch-screens, optical switches, or combinations thereof, or any other type of on-off or variable device capable of providing a digital or analog signal in response to a user action. The user input 42 most preferably enables the user to issue a command for biometric registration as well as the vehicle function commands (e.g., open/close, lock/unlock, start/stop, etc.).

When a person's finger is placed on biometric input device 52 microcontroller 44 retrieves program instructions from memory 54, causes biometric input device 52 to scan the fingerprint, and then stores the resulting biometric signature in memory 54 provided that an appropriate user access level has been received from user input 42. The recorded biometric signature can then be transmitted to vehicle control system 70, thereby registering the person's biometric signature in that vehicle. The vehicle will thereafter recognize the individual with that biometric signature as an allowed user of some degree or scope (e.g., the “access level” specified during registration). The biometric signature may be transmitted immediately after being recorded or stored and sent along with a subsequently entered command and encrypt module 44-1 may be used to encrypt the biometric signature prior to storage and/or transmission, where the access level is the scope of the permission or authorization associated with the biometric signature being sent.

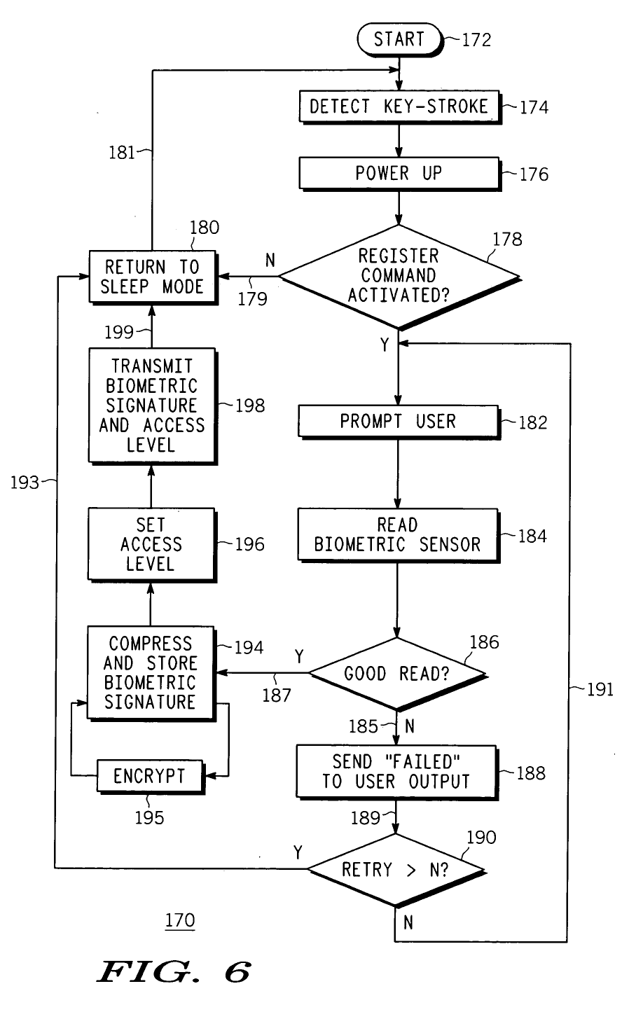

The scope or extent of a person's biometric authorization (i.e., the “access level”) may be set by the user in connection with the biometric feature scan by entering an appropriate function code(s) into user input 42 as subsequently described in greater detail in connection with FIGS. 5-6. For example, if the person's biometric signature is to be recognized for all functions of which biometric key-fob control 40 is capable, then user input 42 is employed to enter a general permission code (e.g., access level=ALL) prior to or subsequent to the biometric signature scan, but generally prior to transmission of the biometric signature to vehicle control system 70. If the scope of biometric signature authorization is to be more limited (e.g., access level=PARTIAL, such as for example, unlock doors only), then a more limited permission code is provided via user input 42. In either case, the permission code corresponding to the allowed access level is desirably, but not essentially transmitted with or incorporated in the biometric signature when sent to vehicle control system 70 so that registration within vehicle 68 desirably, but not essentially takes into account the access level approved for a particular biometric signature. Stated another way, the biometric signature identifies WHO is registered to control functions in the vehicle and the access level identifies WHAT functions that person can control in the vehicle. Encrypt module 44-1 is desirably, but not essentially, provided so that the biometric signature information, and desirably also the access level and commands, can be encrypted prior to transmission to control system 70 of vehicle 68. A corresponding decrypt module in control system 70 strips off the encryption (i.e., decrypts it) to retrieve the original biometric signature and optional access level and commands, etc. This is useful in preventing false authorizations being sent to vehicle 68.

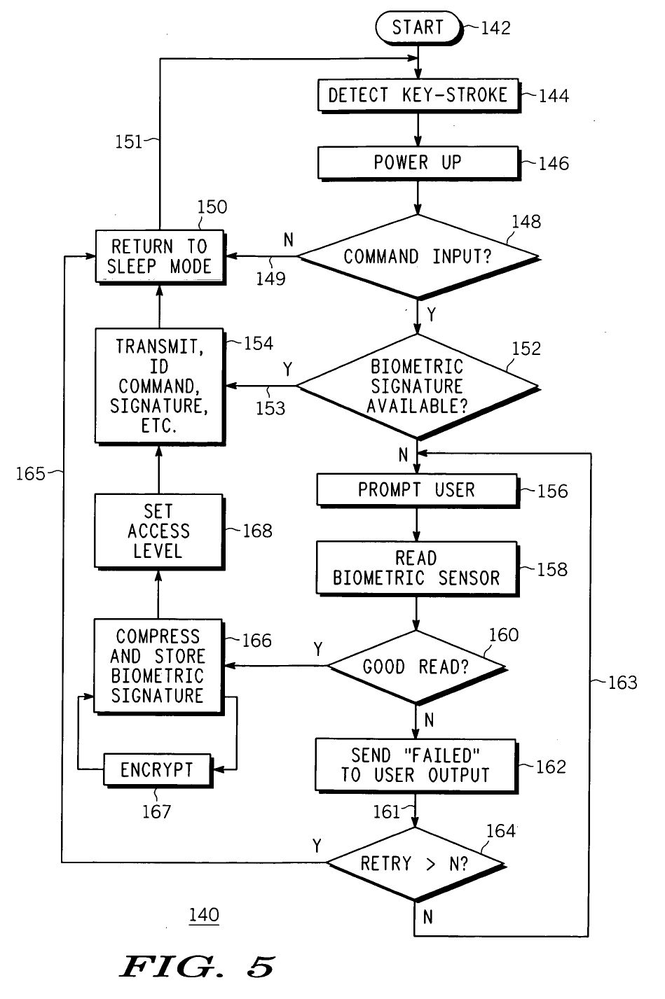

FIG. 4 is a block diagram of vehicle-mounted, on-board, biometric registration and control system 70 adapted to interface with biometric key-fob control 40 of FIG. 3. Control system 70 conveniently may be divided into sub-systems, as for example but not intended to be limiting: (i) key-fob interface 71, (ii) body function control 86 and (iii) other systems 100. Key-fob interface 71 receives RF signal 49 from biometric key-fob control 40 containing, for example, a biometric signature for registration, one or more commands to be executed by vehicle control system 70, and/or a biometric signature for command authorization. Body function control 86 receives decoded and decrypted biometric signatures and commands from interface 71, stores the biometric signatures for registration and later comparison with incoming user signatures and commands. Body function control 86 and other systems 100 carry out authorized user commands (e.g., lock, unlock, start, stop, open, close, etc.). Key-fob interface 71, body function control 86 and other systems 100 are conveniently coupled by vehicle bus 85, but any means of communication therebetween may also be used in accordance with the present invention.

Key-fob interface 71 desirably comprises antenna 72 for receiving RF signal 49 from biometric key-fob control 40. Signal 49 received by antenna 72 is coupled via lead 73 to receiver 74 where it is decoded, that is, demodulated and converted into a base-band signal. The nature of the processing within receiver 74 depends upon the modulation and/or coding scheme chosen for RF signal 49, and any convenient modulation or coding arrangement may be used. Non-limiting examples are AM or FM modulation, phase shift modulation, delta modulation, and other coding and modulation schemes well known in the art. The base-band signal is coupled via leads or bus 75 to microcontroller 76 where it is interpreted and optionally decrypted using optional decrypt module 76-1 via lead or bus 77. Decrypt module 76-1 may be included within microcontroller 76 (e.g., implemented in hardware or software or a combination thereof) or as a stand alone element. Microcontroller 76 retrieves operating instructions from and/or stores intermediate and/or final results in memory 80 via bus 77. Microcontroller 76 is coupled via leads or bus 81 to bus interface 82, which in turn is coupled via leads or bus 83 to vehicle bus 85 and thence to body function controller 86 and other vehicle systems 100. Key-fob interface 71 receives signal 49, decodes and optionally decrypts signal 49 and passes the results for action to body function control 86 and/or other systems 100 via vehicle bus 85.

Body function control 86 conveniently comprises bus interface 88, microcontroller 90, command input 92, memory 94, local biometric input device 96, and optional local user input 98. Bus interface 88 provides any signal conversion needed to condition signals on vehicle bus 85 for use within body function control 86 before being coupled to microcontroller 90 via bus or leads 87 or vice-versa. Microcontroller 90 is coupled via bus 91 to command input 92 via bus or leads 93 and to memory 94, biometric input device 96 and user input 98. Local biometric input device 96 performs an analogous function as biometric input device 52 of biometric key-fob control 40, therefore local biometric input device 96 allows a person's biometric signature to be scanned for registration and/or authorization purposes directly at the vehicle. Register new user command input 92 is available to set in motion the process for registering a new user at vehicle 68 when that needs to be done locally rather than remotely. Biometric input device 96 also functions as a local biometric signature detection device for authorization of previously registered users. User input 98 conveniently provides a local means by which a user may enter a specific functional command (e.g., start, stop, open, close, lock, unlock, etc.) in the same manner and for generally the same purposes as user input 42 of biometric key-fob control 40, as well as for other purposes. Input elements 92 and 98 may be combined or separate, and either arrangement is useful.

Other systems 100 conveniently comprise, by way of example and not intended to be limiting, door locks subsystem 102, driver display subsystem 104, ignition subsystem 106 and other subsystems 108, all coupled by vehicle bus 85. These subsystems 102-108 are merely examples of the various subsystems that can be access-controlled by biometric signatures according to the present invention. Battery 110 with connections 112 provides DC energy to the various elements of vehicle control system 70.

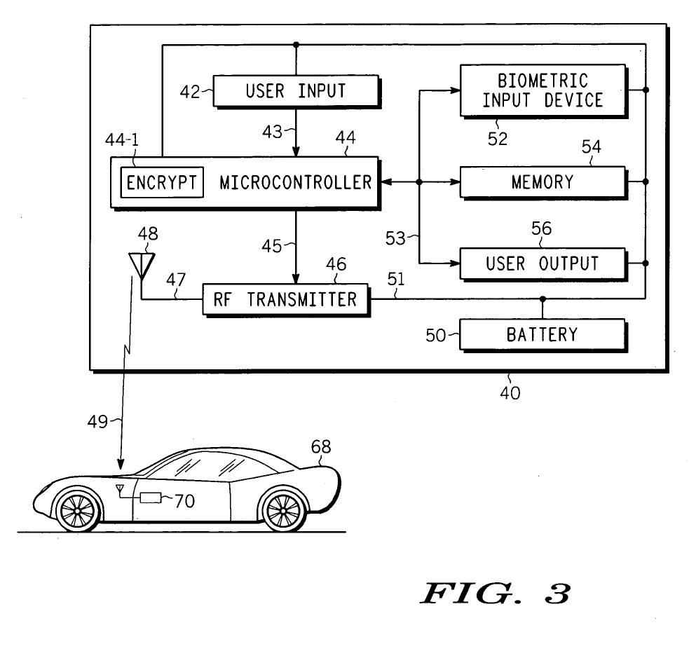

FIGS. 5-6 are simplified process flow charts illustrating methods 140, 170 of operation of biometric key-fob control 40 of FIG. 2, according to an exemplary embodiment of the present invention. Referring now to FIG. 5, method 140 begins with START 142 that occurs when batteries are inserted into biometric key-fob control 40. Unless there is an immediate key-stroke, method 140 will place key-fob control 40 into a sleep state. When a key-stroke is detected by initial step 144 received from, for example, user input 42, POWER-UP step 146 is executed wherein battery 50 is coupled to the other elements of key-fob control 40 In subsequent COMMAND INPUT? query 148, it is determined whether or not the detected key-stroke(s) corresponds to a permitted command, for example, an action command (e.g., open/close, lock/unlock, start/stop, etc.) and/or a registration command (e.g., to register the biometric signature of a new user) or a combination thereof. If the outcome of query 148 is NO (i.e., FALSE), then method 140 proceeds to RETURN TO SLEEP MODE step 150 and key-fob control 40 returns to START 142 as shown by path 151, to await another user action. If the outcome of query 148 is YES (i.e., TRUE) indicating that an allowed command has been entered via user input 42, then method 140 advances to BIOMETRIC SIGNATURE AVAILABLE? query 152 when it is determined whether or not a previously entered biometric registration is still stored in memory 54 of key-fob control 40. If the outcome of query 152 is YES (i.e., TRUE), then as shown by path 153, method 140 desirably advances to TRANSMIT ID, COMMAND AND SIGNATURE step 154 when the key-fob's unique identifier (ID), the entered command, and the biometric signature are sent by key-fob control 40 via RF signal 49 to vehicle 68. When transmit step 154 is complete, method 140 proceeds to step 150 and is returned to the sleep mode to await another user action.

If the outcome of query 152 is NO (i.e., FALSE) indicating that a biometric signature is not already stored in key-fob control 40, then method 140 advances to PROMPT USER step 156 when user output 56 is activated to prompt the user to place a finger, for example, on biometric input device 52 so that it can be scanned. In subsequent READ BIOMETRIC SENSOR step 158 the user's biometric feature is scanned using input device 52 and the result checked in GOOD READ? query step 160 using predetermined criteria stored, for example, in memory 54 to verify that a valid and reliable biometric signature has been obtained. Non-limiting examples of such checks are: (i) did the finger cover a minimum required portion of the scan window, (ii) were the minimum number of comparison points obtained, (iii) did the scan data have the correct format, adequate signal to noise ratio, and so forth. The types of data verification checks should be performed depending upon the particular biometric feature they intend to use. If the outcome of query 160 is NO (i.e., FALSE) indicating that the biometric signature scan was not successful, then in step 162 an “operation failed” alert is sent by microcontroller 44 to user output 56 to warn the user that the biometric scan was not successful and should be repeated (e.g., as shown by path 161, 163). RETRY>N? query 164 is desirably, but not essentially, included in path 161, 163 to count the number (n) of unsuccessful read steps 158 that are executed. If the outcome of query 164 is NO (i.e., FALSE), that is, n≦N, where N is a predetermined number of allowed trials, then as shown by path 163, method 140 loops back to PROMPT USER step 156 and steps 156, 158, 160, 164 are repeated until the outcome of query 160 is YES (i.e., TRUE) where method 140 advances to step 166, or the outcome of query 164 is YES (i.e., TRUE) where method 140 returns to the sleep mode in step 150 as shown by path 165.

If the outcome of query 160 is YES (i.e., TRUE), then method 140 advances to COMPRESS AND STORE BIOMETRIC SIGNATURE step 166 when the information obtained from read step 158 is desirably, but not essentially processed by microcontroller 44 to remove redundant information and, optionally, encrypt the biometric signature information, as shown by ENCRYPT step 167. The desirably compressed outcome, either encrypted or in plain text, is stored in memory 54 and method 140 advances via optional SET ACCESS LEVEL step 168 to transmit step 154 where the fob ID, command, newly determined biometric signature, optional access level, etc., are sent to vehicle 68 using RF transmitter 46.

Optional step 168 is provided to set the access level associated with the particular biometric signature being transmitted. This information is also desirably included in transmission step 154. The user may be prompted to enter an access level for this biometric signature via user input 42 or key-fob control 40 may automatically enter an access level corresponding to the command detected in step 148. Step 168 permits the access level to be set by appending an appropriate header or access code to or within the biometric signature or providing a pointer to access information kept in a separate file from the biometric registration file in vehicle 68. This feature is especially useful when persons of different age or skill level or legal capacity (e.g., has a driver's license or does not have a driver's license) are being registered with the vehicle. Further, while SET ACCESS LEVEL step 168 is shown in FIG. 5 as occurring between steps 166 and 154, this is only for convenience of description. SET ACCESS LEVEL step 168 may be conveniently performed anytime after step 152 where the need for a new biometric signature is recognized and before transmit step 154. While it is preferred to include the access level in the same transmission with the biometric signature, this is not essential, and the access level may be sent in a separate transmission containing a link to the particular biometric signature to which it applies. While inclusion of step 168 is desirable, it is not mandatory. For the most secure mode of operation, it is desirable that a biometric signature should accompany each command sent from key-fob control 40 to vehicle 68 and if one is not already stored in key-fob control 40, method 140 prompts the user to generate a biometric signature to be sent with the command.

FIG. 6 is a simplified process flow chart illustrating method 170 of operation of biometric key-fob control 40 of FIG. 2, according to a further embodiment of the present invention. Method 170 illustrates how a new user may be remotely registered to a vehicle by means of biometric key-fob control 40. START 172, DETECT KEY-STROKE step 174 and POWER-UP step 176 are substantially similar to steps 142, 144, 146 of FIG. 5 and the discussion thereof is incorporated herein by reference. Similarly, RETURN TO SLEEP MODE step 180 is analogous to step 150 of FIG. 5 and the discussion thereof is also incorporated by reference. Following steps 174, 176, REGISTER COMMAND ACTIVATED query 178 is executed when it is determined whether or not the user has provided via a command indicating that a new user should be registered by vehicle 68. If the outcome of query 178 is NO (i.e., FALSE) indicating that the user has not indicated an intention to register a new user, then as shown by path 179, method 170 puts key-fob 40 back to sleep in step 180, and then via path 181 awaits another user input. If the outcome of query 178 is YES (i.e., TRUE), then in step 182 the user is prompted to place his or her biometric identification feature (e.g., a finger) on biometric input device 52 of key-fob control 40. In step 184, which is analogous to step 158, the user's biometric identification feature is read to obtain its signature, and in query 186, which is analogous to query 160 the resulting data is checked against predetermined criteria to verify that it is trustworthy. If the outcome of query 186 is NO (i.e., FALSE) then in step 188, which is analogous to step 162 the user is alerted via user output 56 that the feature scan failed and should be repeated as shown by path 189, 191 via RETRY>N query 190, which is analogous to query 164. The loop of steps 182, 184, 186, 188, 190 may be repeated a predetermined number (N) of trials or until a YES (i.e., TRUE) outcome is obtained in step 186, whichever comes first. If the predetermined number N of trials is reached without a YES (i.e., TRUE) outcome from query 186, then as shown by path 193, method 170 proceeds to step 180 and goes back to sleep, awaiting another user input. If the outcome of query 186 is YES (i.e., TRUE), then method 170 advances to steps 194, 195, which is analogous to steps 166, 167, in which the biometric signature obtained in step 184 is compressed, optionally encrypted, and stored in memory 54 for immediate or later transmission to vehicle 68. In subsequent step 198 the biometric signature is sent to vehicle 68 for registration by vehicle control system 70, via optional SET ACCESS LEVEL step 196, which is analogous to step 168.

As noted in connection with the discussion of key-fob control 40, the access level associated with this biometric signature registration may be appended in SET ACCESS LEVEL step 196. Step 196 is analogous to step 168 or FIG. 5 and the discussion thereof concerning the purpose of the SET ACCESS LEVEL step is incorporated herein by reference. Further, while SET ACCESS LEVEL step 196 is shown in FIG. 6 as occurring between steps 194 and 198, this is only for convenience of description. SET ACCESS LEVEL step 196 may be conveniently performed anytime after step 178 where the desire to register a new user is entered and before transmit step 198. While it is preferred to include the access level in the same transmission with the biometric signature, this is not essential, and the access level may be sent in a separate transmission containing a link to the particular biometric signature to which it applies, either before or after transmit step 198. While inclusion of step 196 is desirable, it is not mandatory.

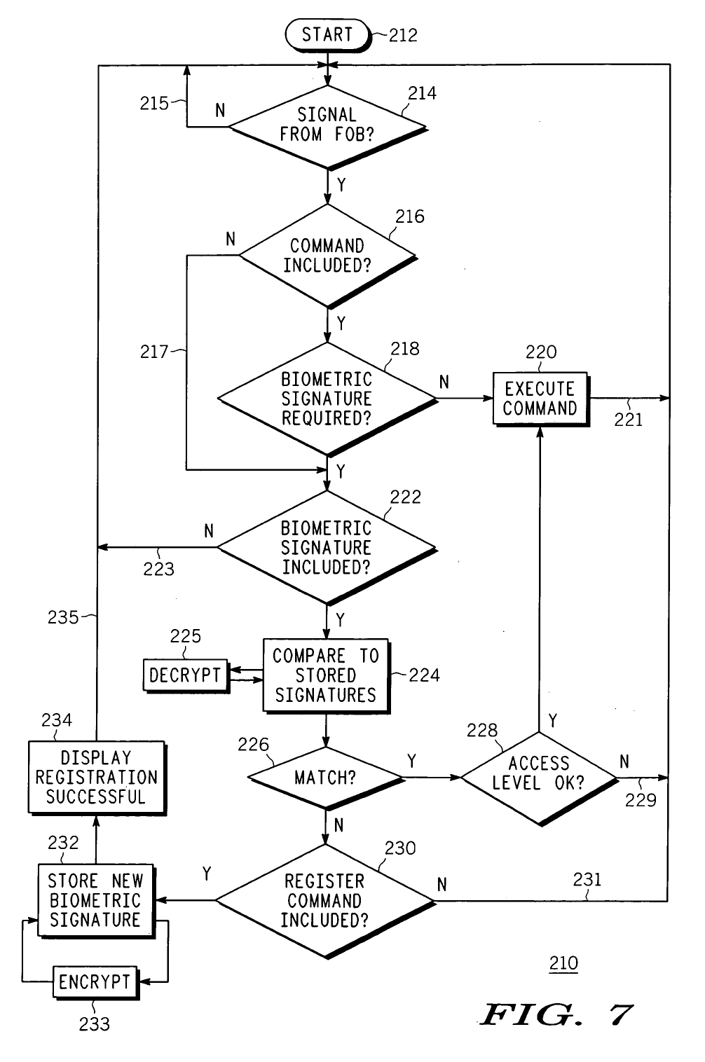

FIG. 7 is a simplified process flow chart illustrating method 210 of operation of vehicle mounted, on-board biometric registration and control system 70 of FIG. 3, according to an exemplary of the present invention. Method 210 begins with START 212, which occurs when the vehicle electrical systems or at least the portions associated with reception of signals 49 and execution of commands therein are energized. For example and not intended to be limiting, those portions of control system 70 associated with functions such as remotely triggered “lock/unlock” operations will be active even when the vehicle ignition is OFF.

Initial query 214 determines whether signal 49 from key-fob control 40 has been received. If the outcome of query 214 is NO (i.e., FALSE) indicating that no fob signal has been received (e.g., during the last sampling interval), then as shown by path 215, method 210 returns to START 212 and awaits the arrival of fob signal 49. When the outcome of query 214 is YES (i.e., TRUE), then method 210 desirably advances to COMMAND INCLUDED? query 216 where it is determined whether or not an allowable command was included in signal 49, or whether, for instance, signal 49 was generated by a random key-push or other false input or comes from a transmitter other than key-fob control 40. Allowable commands are conveniently stored in memory 80 so that the format and content of incoming signals can be compared by microcontroller 76 after demodulation in receiver 74. If the outcome of query 216 is NO (i.e., FALSE) indicating that the demodulated signal does not contain an allowable command or has the wrong format, then as shown by path 217 the incoming signal is tested in query 222 to determine whether it contains a biometric signature. If the outcome of query 222 is NO (i.e., FALSE), then the signal is not of interest and as shown by path 223, method 210 returns to START 212 to await another incoming signal.

If the outcome of COMMAND INCLUDED? query 216 is YES (i.e., TRUE) indicating that a permitted command is present in the proper format, then method 210 advances to BIOMETRIC SIGNATURE REQUIRED? query 218 where it is determined whether or not a biometric signature must accompany the command in order for it to be acted upon. This is conveniently determined by comparing the unique key-fob ID or key-fob command or biometric signature or a combination thereof with an “authorization required” list of key-fob ID's, signatures and/or commands stored, for example, in memory 80. If the outcome of query 218 is NO (i.e., FALSE) indicating that a biometric signature need not accompany the command, then method 210 proceeds to EXECUTE COMMAND step 220 where the received command is executed by control system 70. Thus, vehicle control system 70 can, if desired, continue to respond to some key-fobs not equipped with biometric inputs or to some commands of all key fobs. This can be determined by the designer, vehicle owner or other supervisory authority.

If the outcome of query 218 is YES (i.e., TRUE) indicating that a biometric signature is required in order for the command to be acted upon, then method 210 proceeds to query 222 where it is determined whether or not a biometric signature accompanied or was included with the command. If the outcome of query 222 is NO (i.e., FALSE), then as previously noted, method 210 returns to START 212 to await another key-fob signal. If the outcome of query 222 is YES (i.e., TRUE), then method 210 advances to COMPARE TO STORED SIGNATURES step 224 and associated optional decrypt step 225, where the received biometric signature is decrypted if needed and compared to previously registered biometric signatures stored in memory 80, 94, or elsewhere in vehicle 68, or even off-board using remote communications (not shown) with which some vehicles may be equipped. These steps are conveniently performed by microcontroller 76, decrypt module 78 and memory 80, but may also be performed in other locations in vehicle control system 70 or elsewhere. In following MATCH? query step 226, it is determined whether or not the received biometric signature matches any of those already registered to vehicle 68. If the outcome of query 226 is YES (i.e., TRUE), then method 210 proceeds to optional ACCESS LEVEL OK? query 228 where it is determined whether the received or stored access level is adequate for the accompanying command, that is, is the user (WHO) identified by the biometric signature authorized to issue the accompanying command (WHAT), if any. If the outcome of optional query 228 is YES (i.e., TRUE), then method 210 proceeds to EXECUTE COMMAND step 220 where the received command is carried out. If the outcome of query 228 is NO (i.e., FALSE), then method 210 proceeds to START 212 as shown by path 229 to await another signal from key-fob 40.

If the outcome of query 226 is NO (i.e., FALSE) indicating that the received biometric signature has not been previously registered for vehicle 68, then method 210 proceeds to REGISTER COMMAND INCLUDED? query 230 where it is determined whether the biometric signature is accompanied by a registration command, that is, a command indicating that key-fob control 40 is sending the biometric signature for purposes of registration. If the outcome of query 230 is NO (i.e., FALSE) indicating that the “register” command is absent, then method 210 returns to START 212 as shown by path 231 to await another incoming signal. If the outcome of query 230 is YES (i.e., TRUE) indicating that the “register” command is included, then method 210 proceeds to steps 232, 233 where the received biometric signature is optionally encrypted and, either way, stored in memory 80 or 94 or elsewhere in vehicle control system 70 as an authorized user. It is preferable that the access level associated with that biometric signature also be stored in a manner linked to the biometric signature. If an access level does not accompany the biometric signature, then vehicle control system 70 may automatically assign a predetermined default access level set by the designer, vehicle owner or other supervisory authority. Following registration of the biometric signature, successful completion of this step is desirably, but not essentially indicated on, for example, driver display 104 or other output within the vehicle. If biometric key-fob control 40 and vehicle control system 70 are equipped for two-way communication, then a “registration successful” message may be sent back to key-fob control 40 for presentation on user output 56 as shown in FIG. 2 or equivalent. Two-way communication may be accomplished by replacing transmitter 46 and receiver 74 with suitable transceivers. Following optional step 234, method 210 returns to START 212 to await another fob signal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An apparatus for remotely registering a biometric signature of a user with a vehicle, comprising:
a biometric input configured to obtain the biometric signature of the user;
a transmitter configured to wirelessly communicate with the vehicle;
a microcontroller coupled to the biometric input and the transmitter, the microcontroller configured to:
receive the biometric signature of the user from the biometric input; and
wirelessly transmit a message containing the biometric signature via the transmitter to the vehicle for registration.

2. The apparatus of claim 1 further comprising a memory coupled to the microcontroller, the memory configured to retain the biometric signature obtained by the biometric input after the wireless transmission of the message containing the biometric signature to the vehicle for registration.

3. The apparatus of claim 2 further comprising a command input coupled to the microcontroller and configured to receive a vehicle command from the user, wherein the microcontroller is configured to form the message as a combination of the vehicle command and the biometric signature.

4. The apparatus of claim 1 wherein the apparatus is configured to be a portable apparatus.

5. The apparatus of claim 1 wherein the transmitter further comprises a wireless receiver adapted to receive information from the vehicle about the status of the registration of the biometric signature within the vehicle.

6. The apparatus of claim 5 further comprising an output coupled to the wireless receiver and adapted to present the user with the status of the registration of the biometric signature within the vehicle.

7. The apparatus of claim 1 further comprising an output coupled to the microcontroller and configured to present a status of the biometric input obtaining the biometric signature.

8. A method for remotely registering a biometric signature of a user with a vehicle, the method comprising:
receiving a registration command indicative of a desire to register the biometric signature of the user with the vehicle;
obtaining a biometric signature of the user; and
wirelessly transmitting the biometric signature and the registration command to the vehicle for registration of the biometric signature with the vehicle.

9. The method of claim 8, further comprising encrypting the biometric signature prior to wirelessly transmitting the biometric signature and the registration command to the vehicle for registration of the biometric signature with the vehicle.

10. The method of claim 9 further comprising encrypting the registration command prior to wirelessly transmitting the biometric signature and the registration command to the vehicle for registration of the biometric signature with the vehicle.

11. The method of claim 8, further comprising:
designating an access level for the biometric signature; and
wirelessly transmitting the access level to the vehicle with the biometric signature.

12. The method of claim 11, wherein designating the access level is conducted before receiving the registration command.

13. The method of claim 8, further comprising storing the biometric signature in a memory.

14. The method of claim 8, further comprising receiving a signal from the vehicle indicative of the result of the wirelessly transmitting step.

15. The method of claim 14, further comprising presenting to the user a message indicative of the result of the wirelessly transmitting step.

16. The method of claim 8 further comprising the step of presenting an indicator to the user of a result of the obtaining the biometric signature of the user.

17. A method for biometric signature control of commands issued from a key-fob to a vehicle, comprising:
storing in the key-fob a biometric signature of a user authorized to issue commands to the vehicle;
registering the biometric signature with the vehicle;
receiving a vehicle command via a user input of the key-fob; and
combining the vehicle command and the biometric signature into a message; and
wirelessly transmitting the message to the vehicle.

18. The method of claim 17, further comprising:
determining an access level that specifies commands of the vehicle that are accessible to the a user;
associating the access level with the biometric signature; and
wirelessly transmitting the access level with the biometric signature.
